(19) United States
(12) Patent Application Publication
(10) Pub. No.: US 2016/0253476 A1
(43) Pub. Date: Sep. 1, 2016

(54) System and method for collecting and authenticating medication consumption

(71) Applicant: IRODY, INC., Boston, MA (US)

(72) Inventor: Eyal Bartfeld, Mazkeret-Batia (IL)

(73) Assignee: IRODY, INC., Boston, MA (US)

(21) Appl. No.: 15/150,583

(22) Filed: May 10, 2016

Related U.S. Application Data
(62) Division of application No. 12/538,873, filed on Aug. 11, 2009.
(60) Provisional application No. 61/088,109, filed on Aug. 12, 2008.

(51) Int. Cl. G06F 19/00; G06F 17/21

(52) U.S. Cl. CPC G06F 19/3456; G06F 17/211

(57) ABSTRACT

A method and system for collecting reports of medication consumption, the method including receiving a report including data identifying a medication, an image of the medication and data indicating consumption of that medication, authenticating the identification of the medication by the data and consumption of the medication, and storing the data for future reference upon authentication.

### RELATED APPLICATIONS

The present invention claims the benefit of U.S. Provisional application Ser. No. 61/088,109 filed 12 Aug. 2008.

### FIELD OF THE INVENTION

The present invention relates to a system and method for collecting post-marketing information about medications consumed by patients and consumers.

### BACKGROUND OF THE INVENTION

Medications, and in particular oral medications, are the most common treatment for most health complaints. In recent years the use of medications to prevent and treat chronic conditions has increased considerably. As a result, many people have started taking medications at a relatively young age, on a routine basis, and for their entire lives. However, once a patient leaves the doctor's office, there is no way of knowing how the prescribed medications are actually being consumed. It is known that strict compliance and adherence to medication regimen (prescribed instructions for taking the medications) is critical for ensuring the desired outcome. Additional factors, collectively known as medication errors, may also considerably alter the effectiveness of medications. Often, these factors are not reported accurately by the patients, either because they don't know that they should be reporting them, are not aware of them, or do not want to report them to their care givers.

Many aspects of patients' medical history are well documented. These include lab tests results, medical history of their doctors' visits, records of physiological parameters such as their weight and blood pressure, as well as the prescriptions that these patients received in the past. However the actual medication consumption is not documented or otherwise known and, in many instances, the patients cannot reveal accurate information about what they really consumed.

It is important to note that inputting medications into a web site is different from inputting other data, such as one's children names. Names of medications appear long, meaningless and cumbersome to most people. In the past, when each medication has essentially a single manufacturer, a database of photos of medications existed. However, generic medications that are introduced to the market have different names and appearances from the original medications, but are generally considered as equivalent to the original, which may add to users' confusion. In worse scenarios, users may mistakenly consume a different medication than they intended. In addition, it is important to include the dose (usually expressed in milligrams) when reporting.

Accordingly, there is a long felt need for a better way to input medication consumption—both the medication itself and times of consumption, in a way that will be very reliable, will not be subject to user errors, but at the same time will be quick and easy, so that users will use this technology each and every time they take their medications.

### SUMMARY OF THE INVENTION

The present invention relates to a system and method to aid medication consumers to report the consumption of medication every time they do so and choose to report, and to permit every report to be authenticated for validity. This invention provides capabilities to accurately document actual medication consumption. In addition, a method of authenticating patients' reports in order to generate a scientifically accurate body of information is also provided. The authenticated medical consumption data may be used to populate a database of information organized in a manner that provides targeted and relevant information to patients and caregivers about the medications that they are interested in. This information may include the correct method for taking various medications and the effect of the medications, particularly taking into account combinations of medications, characteristics of the population taking the medication.

There is provided, according one embodiment of the present invention, a system including a central computer system, connected to users via the Internet through a wired, wireless, or cellular network. The system includes computer software that enables easy interaction with users by providing a plurality of ways users can input their actual medication consumption effectively. It includes data analysis software targeted towards fraud prevention and real-time identification of which medication was actually consumed.

There is, thus, provided according to the invention, a method for collecting reports of medication consumption, the method including receiving a report including data identifying a medication, an image of the medication and data indicating consumption of that medication, authenticating the identification of the medication by the data and consumption of the medication, and storing the data for future reference upon authentication.

There is further provided a system for collecting and authenticating medication consumption reports, the system including a server for receiving reports including data identifying a medication, an image of the medication, and data indicating consumption of that medication, a plurality of user interfaces, each including a processor, coupled to the server for uploading reports to the server, a processor in the server for authenticating said data, and a database in the server for storing the authenticated data for future reference.

In addition, there is provided according to the invention, a method of creating an electronic chart, the method including providing an image of a medication captured by a user, and displaying the image of the medication adjacent a name of the medication in a personalized medication regimen of the user.

According to one aspect of the invention, there is provided an apparatus for displaying a medication regimen of a user, the apparatus including a processor for reading a medication regimen of a user from a personalized database representing medication regimen data of the user for display of a medication regimen, an interactive user interface for uploading data and images by the user to the personalized database, wherein the medication regimen data comprises a set of user medications and a corresponding schedule of medication consumption, and wherein the database further includes at least one image of a medication uploaded by the user and associated with each name of a medication, and a display for displaying the medication regimen of the user, wherein the medication regimen includes a display of the image of the medication adjacent the name of the medication.

According to another embodiment, there is also provided an online information support resource and forum for patients and caregivers to add their comments, ask questions, investigate their symptoms by learning about the experiences of others, read study analysis reports and provide and obtain post-marketing information about their medication, that may not have been brought to their attention when they started consuming the medication, or that may not have even been known at the time.

### BRIEF DESCRIPTION OF THE DRAWING FIGURES

The invention will now be described in greater detail with reference to the preferred embodiments illustrated in the accompanying drawing wherein:

FIG. 1 is a schematic illustration depicting the overall design of a system and various ways of inputting medication data, constructed and operative in accordance with the preferred embodiment of the present invention.

FIG. 2 is a simplified flow chart illustrating a few examples of ways users interact with the system, according to one embodiment of the invention;

FIGS. 3A and 3B are schematic illustrations of a cellular phone having a built-in camera, as used to upload an image of a user's medications, according to one embodiment of the present invention.

FIG. 3c is a flowchart illustrating uploading an image of his/her medications by using the cellular phone of FIG. 3A, according to one embodiment of the present invention.

FIG. 4 is a schematic illustration of a system for uploading an image of a medication by using a digital camera, according to one embodiment of the present invention.

FIG. 5 is a schematic illustration of a graphical user interface display screen to enable users to report their medication consumption without requiring means of imaging, constructed and operative in accordance with one embodiment of the present invention.

FIG. 6 is a schematic illustration of a graphical user interface display screen showing user data that is updated and displayed in real-time, in accordance with a preferred embodiment of the present invention.

FIG. 7 is a flowchart illustrating an algorithm for image processing and medication classification, according to a preferred embodiment of the invention.

FIG. 8 is a flowchart illustrating an algorithm for computing image authenticity, according to a preferred embodiment of the invention.

FIG. 9 is a schematic illustration of an information database for an individual user, constructed and operative in accordance with one embodiment of the present invention.

FIG. 10 is a schematic illustration of a graphical user interface display screen for an individual medication found in the information database, constructed and operative in accordance with one embodiment of the present invention.

FIG. 11 is a schematic illustration of a personalized computerized drug regimen.

### DETAILED DESCRIPTION OF THE INVENTION

The present invention relates a system and method for aiding a medication consumer to report each time he or she consumes a medication, thereby encouraging him to report, and a method for authenticating each report for validity. For purposes of the invention, validity means that the report refers to the actual medication taken by the consumer at the time of taking it, so as to minimize or prevent fraudulent reports. According to one embodiment, this is accomplished by providing means for receiving a live video or other real-time image of the medication or of the consumer consuming the medication which shows the medication the consumer is actually consuming, which can be compared with the medication the consumer is reporting that he is consuming. Thus, the consumer shows his or her medication to a webcam on-line, in real time, or stands before the webcam while taking the pill, or using video conferencing on a suitable cellular phone, or provides an image in such a fashion that the date and time cannot be faked. If the medication is correctly identified by the name indicated by the consumer, the report would be authenticated. This authenticates the taking of the pill or capturing the image or images at that very moment. Alternatively, if the consumer is not in front of a computer or does not have a real time option available, authentication may be accomplished by providing means for uploading a photograph of the medication as it is about to be consumed by the user, and means for authenticating the photograph, as by confirming that the photograph is unique (as explained below).

It will be appreciated that, for purposes of the invention, the “image of the medication” may be an image of a pill, itself, or of the medication packaging, such as a vial (for injections) or the packaging of the medication to be used (where the medication may be in pill, ointment, cream, patch or any other form).

Once these photographs or images are available, they can be used in a multitude of applications, for example, providing an illustrated chart displaying a user's medicine regimen. Additionally, the authenticated medical consumption data may be used to populate a database of information organized in a manner that provides targeted and relevant post-marketing support to patients and caregivers concerning the medications that they are interested in.

For purposes of the present invention, ‘unique’ is a term which relates to a particular image of a medication. The uniqueness test is to verify that an image is different from all other images stored in the system and, therefore, it is not a mere digital copy of an old image, so it can be assumed it was indeed a fresh image just taken by the user. Thus, a ‘unique’ picture is one which appears only once in the system, i.e., no other picture that is digitally identical to the current picture is stored in the system. The uniqueness test is to prevent users from storing a digital picture on their computer and uploading the same picture multiple times. The test provides the benefit of knowing that at least the user took an original picture every time he uploaded a picture to the system, making it more probable that the user, indeed, took a different pill or pills each time he or she reported to the system about a medication taking event. The test for uniqueness, which is preferably embodied in software, relies on the fact that two images may look similar, but are not digitally identical, if taken separately.

‘Authentic’ is a term which relates to an entire report by a user, and indicates that the medication which the user took (and preferably photographed) is, indeed, the medication he reported it was. Authentication preferably involves the steps of image recognition to match the name of the medication a user took, as reported by the user, with an image of the medication, also provided by the user, in conjunction with the event of taking medication. Authentication may involve a test of image uniqueness, according to a preferred embodiment of the invention.

The terms user, consumer and patient will be used in this application interchangeably. The reason for this is that medications may be consumed for reasons other than for the treatment of acute diseases. For example, people take cholesterol reducing medications without being defined as “sick”. Therefore many people who consume pills are likely to benefit from the present invention. Additionally, the terms drug, medication and pill will be used interchangeably, as will be the terms image and picture.

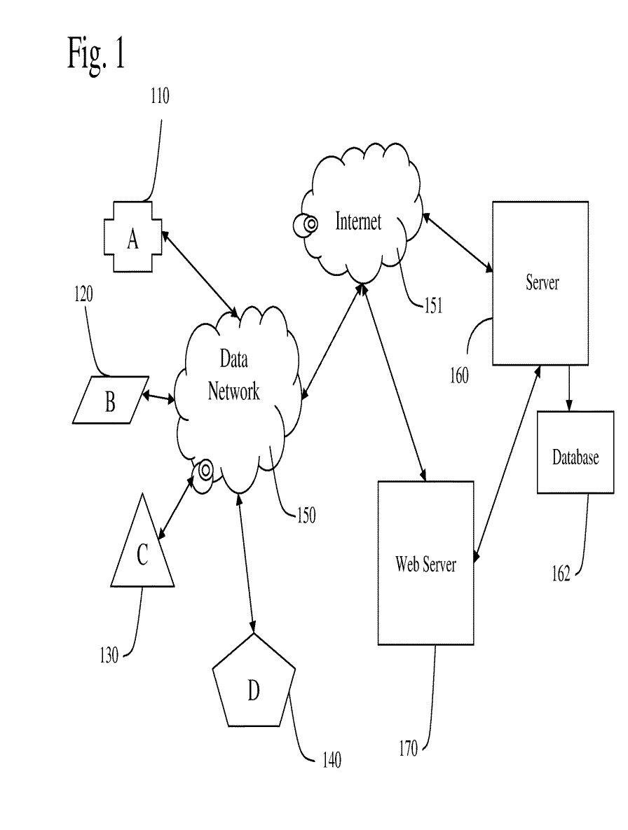

FIG. 1 depicts an overall design of a system, and various methods of inputting medication data, according to one embodiment of the invention. The system includes a server 160 for receiving reports by users that include data identifying the medication they are taking (i.e., the name), an image of the medication and details of consumption of the medication—time, date, etc. A plurality of user interfaces having processors, here illustrated as user terminals 110, 120, 130, 140, are coupled to the server 160, as via a data network 150 and/or the internet 151, for uploading the reports of their users. The server includes a processor (not shown) for authenticating the data uploaded by the users, and a database 162 for storing authenticated data. A web server 170, accessible from any web browser, may also be provided. The web server allows users to perform medication consumption input, as described elsewhere in this application, and preferably also receive the users' consumption reports, and selectively enable family members and care givers access to their data.

Four user input terminals, user terminal A (110), user terminal B (120), user terminal C (130) and user terminal D (140), are shown. User terminal A is a home PC connected to the system through the Internet. User terminal B 120 is a cell phone equipped with a camera connected to the system through a cellular network, user terminal C 130 has an interface to a digital camera, and user terminal D 140 is a special purpose device, also called a pill scanner in this application. Preferably, the image is taken and uploaded in real-time, as by live video from cell phone, web cam, digital camera, an image sent from a cell phone, or any other fashion in which the date and time cannot be changed by the user. When offline, analysis for determining time and date of photograph will be required.

The text below describes how these different types of users, who have different kinds of equipment, will input their medication consumption to a server 160, through a data network 150. An example of such a commercially available data network is FIOS, commercially available by Verizon, USA. The data service is then connected to the Internet 151 which is a global data network. Server 160 is connected to the same Internet via available means commercially available by hosting companies such as Yahoo, CA, USA.

A preferred method of using this system is that users, prior to taking their medications, will take their pill or pills out of their storage places (which may be pill bottles, cans, blister packaging or the like), place these pills on a flat surface, such as a kitchen or path counter, preferably also take a picture of these pills as described below, and then consume the medication orally. Of course, the images should have enough details to identify the pill, but modern digital cameras and even cell phones are equipped with high resolution cameras and, in many cases, even a flash mechanism. These cameras also have automatic focus capabilities, which ensure high enough quality and details capturing. The instructions to the user will direct him or her to place the pills or other medications so that the code embedded would be captured in the image. While primarily discussing medications in the form of pills in this application, it should be noted that the invention is not limited to pills. Users may also use the system and method described herein if they are using syringes for injections or medications in a liquid form. In such cases, a picture of the syringe or the bottle may be used wherever pictures or images are discussed in this application.

In some cases, the pictures are to be uploaded to a server 160 for processing. In this case, relevant supporting information may also be uploaded to the system through the user's input terminal. In case no camera is available, users can still report to server 160 that they have taken medications, which kind, and at what time, even without a picture of the medication. This report, which is valuable but obviously is less reliable and authentic than an actual picture, will be added to the user's records.

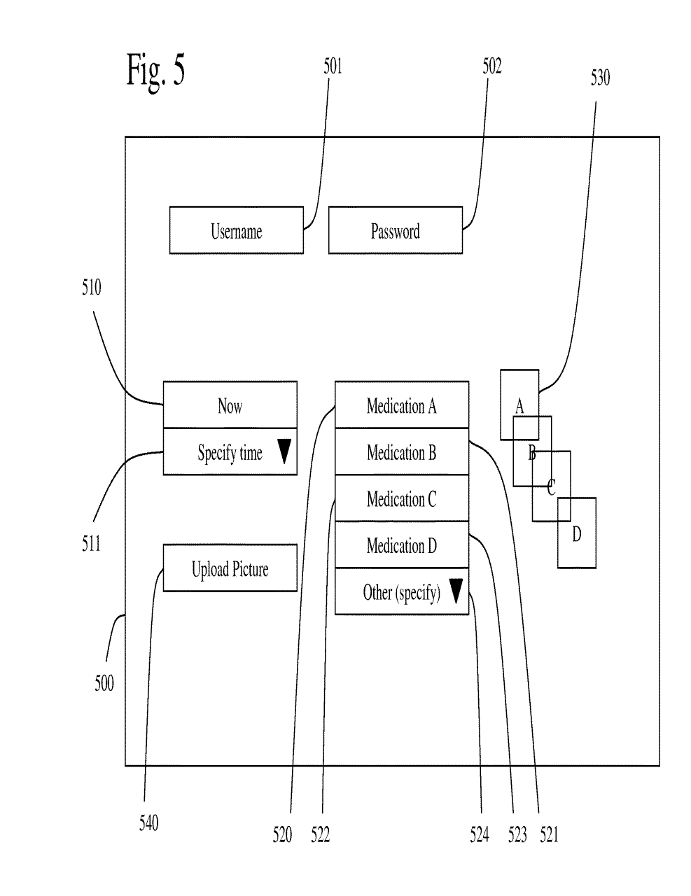

User terminal 110 is a regular personal computer equipped with a web browser, used to access the web site to input the user's medication consumption history, using a pc-based web browser, a keyboard and a pointing device. This interface is described with relation to FIG. 5.

User terminal 120 is a cell phone that is equipped with a camera. There are many cell phone models on the market that are equipped with a camera, such as the RAZR V3, by Motorola Inc., PA, USA. Typically, these cell phones are also equipped with the capability of taking a picture (also referred to as an image in this application) and sending that picture to an email address. The final destination of this email is server 160, which optionally is equipped with software enabling server 160 to receive the message, extract the picture data, and forward the picture data, together with additional identifiers, such as the caller ID of the cell phone which sent the message, to further processing, as described below. This feature of a cell phone is also called “picture messaging”. This service is often based on MMS (Multimedia Messaging Service), which is a standard for telephony messaging systems. Alternatively, a cell phone can be loaded with a special application that will take the picture, compress it and then send the picture to server 160.

User terminal 130 is a digital camera, such as Canon PowerShot G9, which is commercially available in most electronics retail stores such as BestBuy. The user first takes a picture of the medications. Then the user consumes the medications. After that (or alternatively, before that), the user transfers the image to a PC as is known. The user then uploads the image to server 160 via a web browser by logging into his account, and then uploading the image to the Internet, as commonly accomplished by sites such as Flicker.com, as an example.

User terminal 140 is a special purpose device, such as a pill scanner, which is a dedicated imaging device optimized to take pictures of pills and which is part of the network. The pill scanner sends an image or images of the medications to server 160, preferably using an encrypted protocol to protect privacy of users. As another alternative, the user may use a special pill box or pill organizer. The pill organizer is a single container or a matrix container having cells, for each day of the week, or even multiple cells per day, for morning, noon and evening medications. This organizer has special circuitry which detects the event of opening the cap or a cell's cover or lid. The organizer is coupled to the network and, via the data network 150 and the Internet 151, sends the event details to server 160. Event details preferably include date, time, user ID, and pill cap or cell lid ID. This enables server 160 to note the event in its records. Computerized and networked pill caps are known, such as Simpill.

As an alternative, the special purpose device may send event details as described via other connectivity methods, such as a modem connected over a regular telephone line, data over a cellular network, or SMS (text message) via a cellular network. In addition, according to a preferred embodiment of the invention, a web page or service, accessible from any web browser, is offered. The web page allows users to perform medication consumption input, as described elsewhere in this application, and preferably also receive the users' consumption reports, and selectively enable family members and care givers access to their data. The web page or service preferably runs on a web server 170, connected to the Internet and to server 160. Since server 160 stores private information about users and their medications, preferably web server 170 is connected to server 160 via a separate network interface, using protected communications, as known. According to another embodiment of the invention, server 160 will not be connected to the Internet at all, and all traffic from and to server 160 will flow through web server 170.

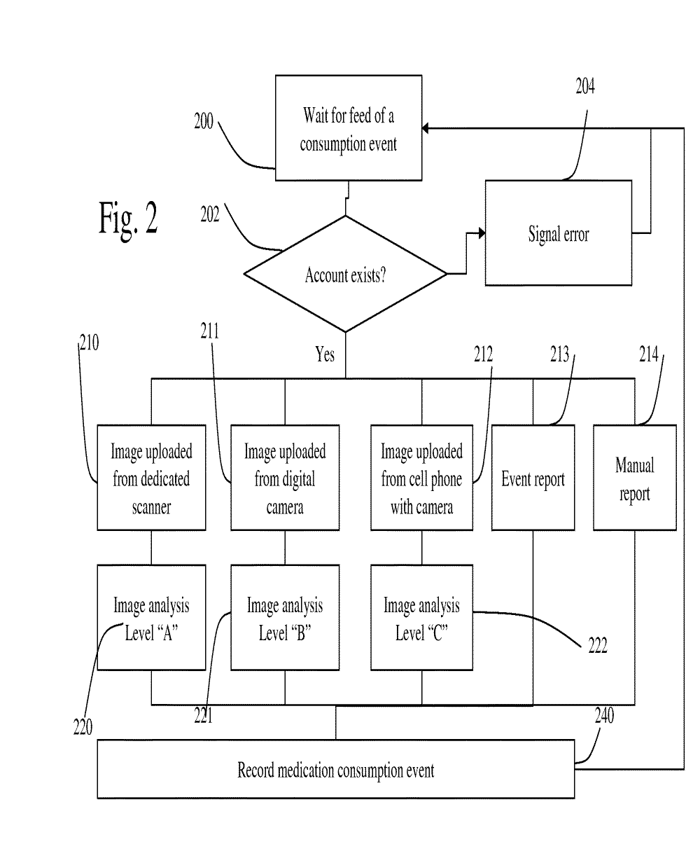

FIG. 2 is a simplified flow chart showing how users interact with the system and which computer processing is required for each type of input. It also describes how the system updates medication consumption data and assigns a reliability score to each report. In step 200, the program is in idle mode, and is waiting for an input. According to a preferred embodiment of the invention, the input contains an image or images of medications. According to another embodiment of the invention, the input does not contain any image. The input may arrive via multiple paths. It can be a web or HTTP IP communication, it may be data over another IP protocol, or it may come from a cellular network as a message, such as SMS. If the input is via IP communication, there is no need for any special handling, since server 160, which is running the program described in this Figure, is connected to the Internet already. However, if the input is delivered via the cell phone network, then the cellular network must deliver the SMS via IP to server 160 of FIG. 1. There are known methods for this, for example, a short code service, commercially available from companies such as Neustar, Va., USA. Once an input is received in step 200, there is a verification and authentication step at 202. According to a preferred embodiment of the invention, the input contains an identifier that uniquely identifies the user. This identifier may be a cell phone number, a combination of a username and a password—preferably together with a MAC address of the user's PC for better security, an ID (such as serial number or MAC address) of a pill scanner or of a computerized pill organizer or dispenser. Depending upon the information provided, the program performs a query in a database of users. If the user does not exist in the system, control proceeds to step 204, where an error is flagged. According to a preferred embodiment of the invention further investigation will be carried out, because this may be an attempt to illegally invade the system.

If the account details are valid, the next step is dependant upon the type of data input. If the data was generated by a pill scanner, then step 210 will be implemented. If the data includes an image or images from a cell phone, step 211 will take place. If the data contains an image or images from a digital camera, step 212 will follow. If there are no images in the data, and it originated from a computerized pillbox, or from a device of a similar nature, step 213 will follow. If the data was manually input by the user, step 214 will follow.

Since it is crucial to have an accurate record of what really was consumed, a reliability score (RS) is attached at each of steps 210, 211, 212, 213 and 214 to this particular instance of medication consumption. The RS is correlated to the reliability of the method of capturing the image and is selected by determining the method of capturing the image and assigning a RS according to said method of capturing. A pill scanner generates data that has the highest RS. Then, in descending order, appears data that is accompanied by one or more images generated during a live video conference, by a digital camera, data from a cell phone camera, data from a computerized pill box, and lastly data that was fed in manually by a user. By way of example, in step 210, RS is 10, in step 211 RS is 9, in step 212 RS is 7, in step 213 RS is 5 and in step 214 RS is 2. The RS may be used for statistical data collection for researching patterns of consumption among large populations or for any other research or data analysis purposes.

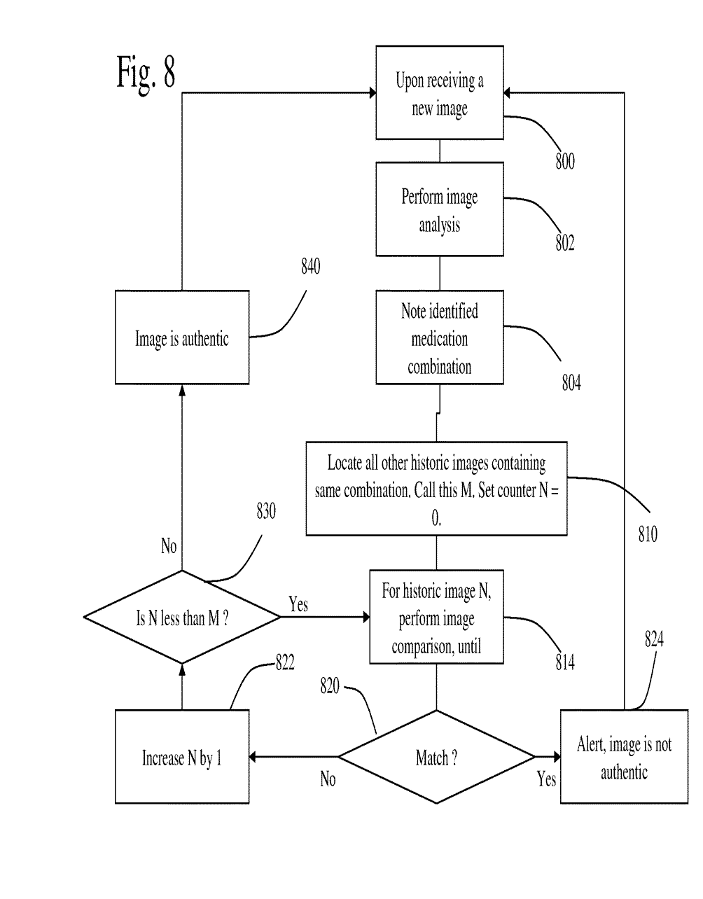

In steps 220, 221 and 222, image analysis is performed in order to automatically identify the medications just consumed. In addition, according to another embodiment of the invention, all pictures are stored, for future reference and verification. This may be helpful for future medical research. If an adverse drug event (ADE) is identified, in the future, for this user, then additional direct evidence, in the form of actual pictures of medications taken, may be useful in investigating the event. According to another preferred embodiment of the invention, in steps 220, 221, and 222, further analysis is performed, to ensure that each image is unique and authentic. The reason for this is that some users may be tempted to re-send the same image many times, or that spammers may feed the system with false information, as is the case with other Internet services, such as in email. The image analysis in these steps is performed by comparing the current image with previously stored images of users who use the same medication or medications. FIG. 8, described below, depicts this comparison in detail.

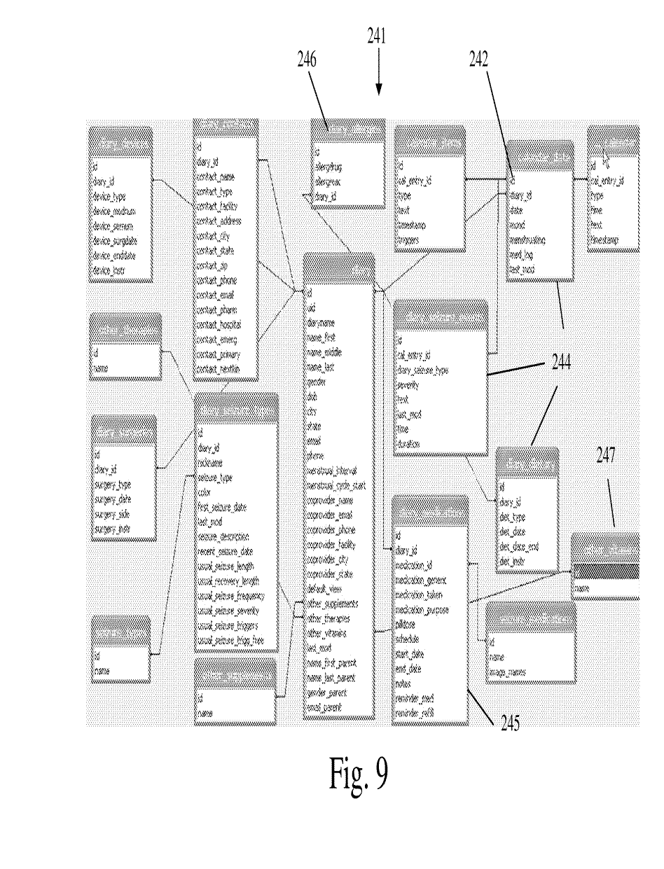

Following image analysis, in step 240, all the data is stored. At this stage the algorithm has all the information that it requires: the user ID, time, date, medications taken, the reliability score (RS), and if available, the raw images. This information is now stored in a way that will enable further efficient retrieval of this information. Preferably, the information is stored in a database, such as MySQL, that is freely available on the Internet. One example of such a database 241 is illustrated in FIG. 9. In a preferred embodiment, each user has a user number or ID 242 associated with his or her username. The user ID is used as an index to a plurality of user tables 244. The tables store each of the user's events, such as taking medicines 245, as well as other important medical information about the user, as desired, such as allergies 246, supplements 247, etc. The same user ID can be used with additional tables, such as a non-prescription drugs table or any other desired table. Following data storage, the program returns to step 200 and waits for a new consumption event.

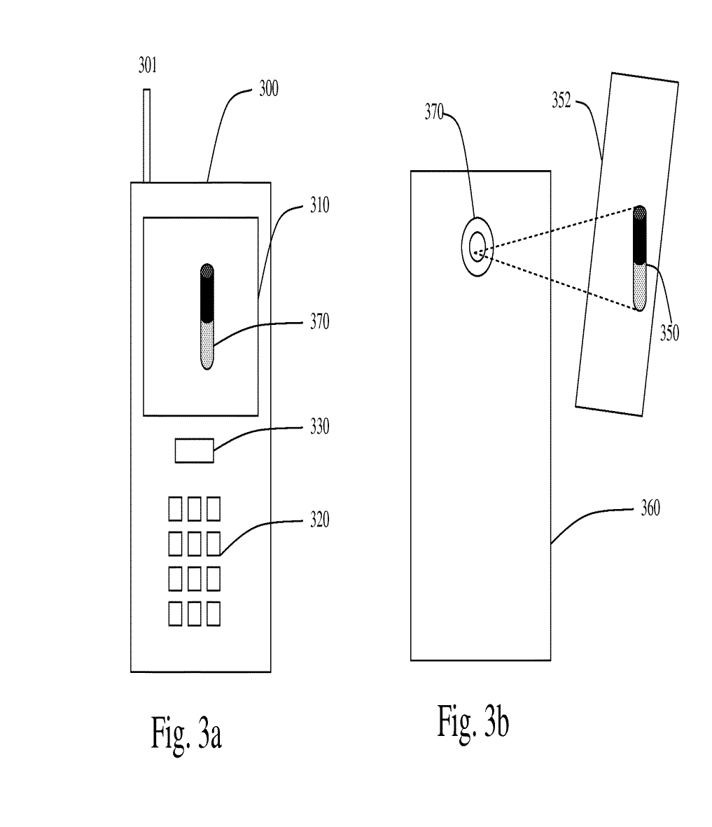

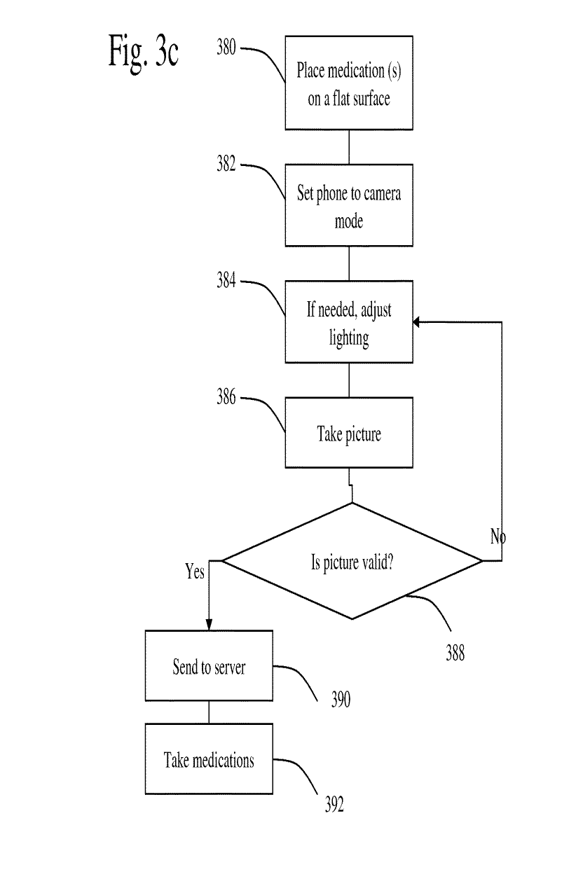

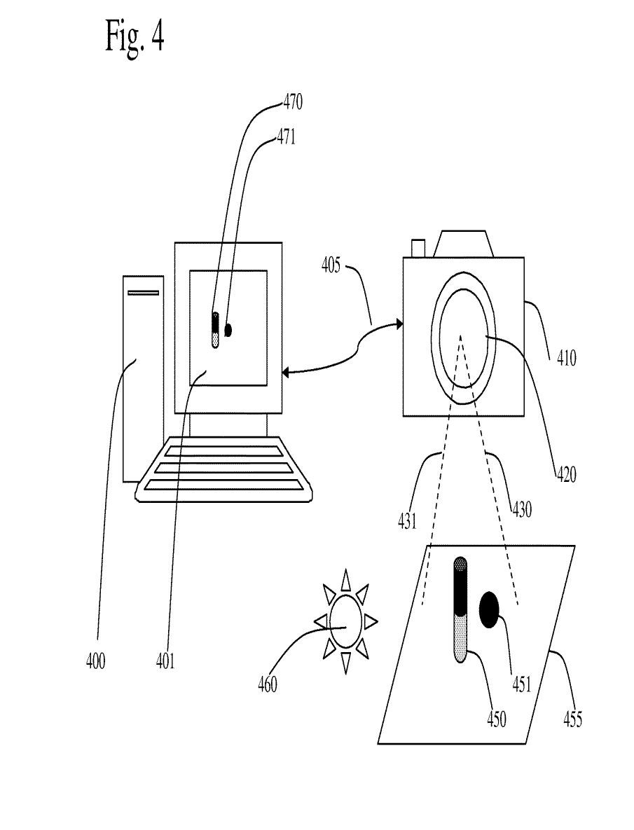

FIGS. 3A and 3B are schematic illustrations of a cellular phone having a built-in camera, as used to upload an image of a user's medications, according to one embodiment of the present invention. FIG. 3A depicts a front view of a cell phone 300 used by the user, and FIG. 3B is a view of the back 360 of cell phone 300. In this embodiment, the cell phone is equipped with a camera, and the camera's lens 370 is located on the back side 360 of the cell phone. It should be noted that each cell phone has a different design and that the camera's lens may be located elsewhere on the phone. The user, by pressing a special key 330 or a sequence of keys, as applicable to the particular model and setup of the cell phone, activates the camera mode. Preferably, the camera mode enables the user to view the image in real-time, on the display 310 of the cell phone. According to a preferred embodiment of the invention, the medication that is about to be consumed is placed on a flat surface 352. The dotted lines extending from lens 370 to medication 350 represent the camera's field of view. The field of view can be adjusted by the user, by moving the cell phone closer to or farther away from the medication, as is common when taking pictures. Preferably the cell phone has an auto focus capability so that the user need not focus the picture. According to another embodiment of the invention, a light source is used to create a better image. Such a light source is not shown in this figure but is depicted at 460 in FIG. 4, and will be used in a similar way as is shown therein. By looking at the image in the display 310, the user adjusts the cell phone, so as to ensure that a sharp image 370 of the entire medication 350 or medications appears in the display 310. The user then presses a special key 330 or a sequence of keys, as applicable to the cell phone model and setup, and the image is transmitted via antenna 301 and is processed as described above. In addition, where the cell phone has video conferencing capabilities, the user preferably sends a picture or video of himself, while taking the medication.

FIG. 3c is a flowchart showing the user's actions, according to one embodiment of the present invention, in taking a picture and uploading it to a server for processing, using a cell phone as described FIG. 3A. In step 380, the user places a medication or medications on a flat surface, and then sets the phone to camera mode in step 382. In step 384, the user adjusts the lighting and field of view, as needed, by looking at the cell phone display to verify that the images look sharp and good, as explained. In step 386, the user takes a picture, and examines it further by looking at the image as actually captured on the cell phone display. If the picture is not good, the user repeats the sequence, starting at step 384. If the picture is satisfactory, the user presses the key in order to send the picture, step 390, to the server, and then the user consumes the medications, step 392.

FIG. 4 depicts user actions required for uploading an image of his/her medications using a digital camera. In this embodiment of the invention, the user uses a digital camera 410 to take a picture of medications 450 and 451 that he or she is about to consume. These medications are preferably placed on a flat surface 455, although this is optional. As another option, the user may use a light source 460 to create more uniform illumination over medications 450 and 451, which may yield a better picture. Looking at the camera's display, which is typically located on the back of the camera and is not depicted in this figure, the user adjusts the field of view, boundaries of which are depicted by the dotted lines 430 and 431, by adjusting the distance from the medications, focuses via lens 420, and optionally adjusts the placement and direction of light source or light sources 460. Alternatively the flash element installed in many popular digital cameras may be used, if additional illumination is required, or in order to improve the quality of the picture. Once the user is satisfied with the image, he or she takes the picture, and stores it in the camera's digital storage or memory, as is common in digital photography. Following this, the user transfers the image or images to a computer 400. This may be accomplished by linking camera 410 to computer 400 via a special cable 405, such as a USB cable, or by any other means, such as wireless connection, or by physically placing the camera's memory card in a reader attached to or built-in computer 400. All this is known in the practice of digital photography. Then the user logs into the medications service as is described in FIG. 2, authenticates himself by typing in username and password, and then uploads the picture or pictures to the server, as known in web applications such as Flicker.com. Optionally, the image can be viewed on the computer screen 401, medications 450 and 451 appearing as 470 and 471, for verification, prior to it being uploaded. Alternatively, the image may be sent as an email attachment to the server. The email will require user authentication details. For example, an email address can be assigned in the form: my-user-name@service-name.com where “my-user-name” is some unique identifier of the user and “service-name.com” is the email server name. Server 160 will process this information and identify the account details from the email. Alternatively, or in addition, the images and other user identity details may be encrypted to protect the privacy of the users.

FIG. 5 depicts one embodiment of a user interface to enable users to report their medication consumption without requiring imaging of their medications. According to a preferred embodiment of the invention, this user interface may be embedded as a web page or pages, running over web server. According to yet another embodiment of the invention, the user interface presented in this figure and the logic behind it may be implemented as a software application running on a PC (often called PC client software) or as a software application running on a cell phone (also known as cell phone client software). This software application communicates with the server (e.g., server 160 in FIG. 1) over any available data communications channel. The function of this user interface is to enable users to log into their accounts, and feed in data about their consumption of medications. Preferably, a user uses this interface or software application each time he or she takes medications. The availability of this interface over the web and over cell phones provides an element of mobility and enables users to perform this task even when they are away from their homes.

The user starts by entering his or her username 501 and password 502, as is common on the Internet. Then he may input his medication consumption by uploading an image by selecting option 540. He can also specify the time at which the medications are consumed. Time of consumption may be entered by selecting option 511. If an image is uploaded, the default is “now”. However, a user can specify the time of actual consumption, if he inputs the event at a later time. If the user prefers to enter the medication taken via manual input, and also provides a picture, he can click on that particular medication by clicking on the button with its name. These medication specific buttons preferably will present all the names of medications this particular user is supposed to consume. In the example shown in FIG. 5, the user consumes four medications called A, B, C and D. They are represented by buttons 520, 521, 522, and 523, respectively. Preferably, when the user selects one or more of these medications, a picture of the medication appears in a display 530, as an additional assistance to the user and in an attempt to reduce or prevent errors during the input process. The medications that the user is prescribed will be pre-stored in the user's records. The pre-stored medications data will be fed into the system by either the user or a member of his or her family when opening or updating the account, or, alternatively if available, the data will be read in automatically from a central medical information depository.

According to another embodiment of the invention the medications prescribed or consumed may be obtained from secured personal digital medical data storage, such as a special memory stick. Button 524 enables input of additional, preferably incidental medications consumed, for example, pain relief medication, such as over-the-counter Advil.

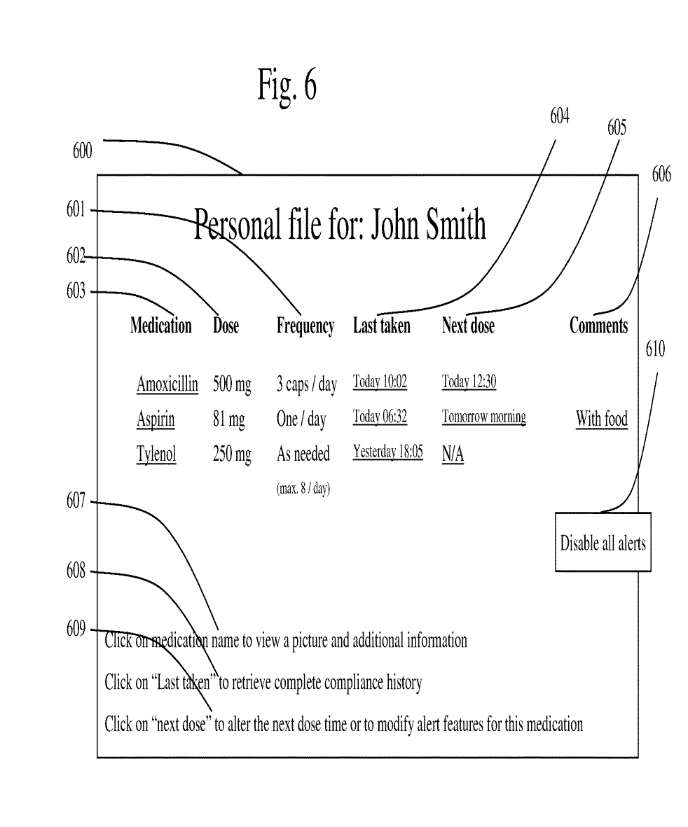

FIG. 6 is a schematic illustration of a graphical user interface display screen showing user data that is updated and displayed in real-time. A personal file web display 600 is shown, according to a preferred embodiment of the invention. This screen is presented to the user after the user has logged into the Web server, as described regarding FIG. 5. The field headed by column header 603 shows the medications that are on file. According to a preferred embodiment of the invention, the user can click on each entry in this field and receive additional information about the medication. Such information may include a picture of the pill, a barcode for a syringe, an explanation about the activity of the medication, indications, contra-indications, known drug-drug interactions with other medications or with food or with food additives, medication usage instructions, normal dose ranges, what to do in case of over-dose, common side effects and the like. According to one embodiment of the invention, banner 607 is displayed to encourage users to read this additional information.

Field 602 presents, for each medication, the dose this user must take. Preferably, this information, as well as all the other information in this page, is taken out of a database that is maintained and updated on an on-going basis by the Pod server and, in some cases, by the Web server. One such example is described in detail below. Field 601 shows the frequency of consumption for this medication, for example, three pills per day.

Field 604 displays the last time this medication was consumed by the user. Since the Pod feeds back to the Pod server each time any medication is consumed, the Pod server maintains detailed consumption records in a database, and this information can be accessed by the Web server for display and review, both by the user, as shown in this Figure, but also by the care giver or the pharmaceutical company that produces the drug, for follow up and research purposes. Known security and privacy measures must be taken in order to ensure that only authorized people or entities are able to access this data. According to one embodiment of the invention, the user can click on this data field and view his/her consumption history. A banner 608 can direct the user to do so, but other known user interface graphic elements, such as a bubble that pops up when the pointer is over the data field, or other known Internet interface methods, can also be applied here.

Field 605 shows the expected times at which the next dose should be consumed. As the medication regimen is known to the system, the system can automatically calculate the expected time for the next dose of that particular medication. By clicking on this data field, the user can override the next expected time, and modify alert techniques by which the system will to notify both the user and, potentially, a care giver if this medication was not consumed on or around the expected time. Field 606 contains particular comments about the medication. According to one embodiment of the invention, the user can click on an item in this list to modify or personalize the comment. Button 610 exists in this screen, according to another embodiment of the invention in order to enable the user to temporarily block all alerts. This is useful when, for example, the user is planning to go on a trip outside of the coverage of a cell phone network and may not be able to use the system for hours or days. If the user selects this option, the text on this button is changed to “enable” so that the user can re-enable the alert function, once he has returned. Known error detection techniques, such as a time out after which alerts are re-enabled, scheduled re-enablement, or automatic re-enablement triggered the next time the user logs into the system, are also implementable. According to another embodiment, additional information, such as help texts 607 or 609 may exist on the page, as well as additional elements, such as advertisements or promotional information as is customary with web pages.

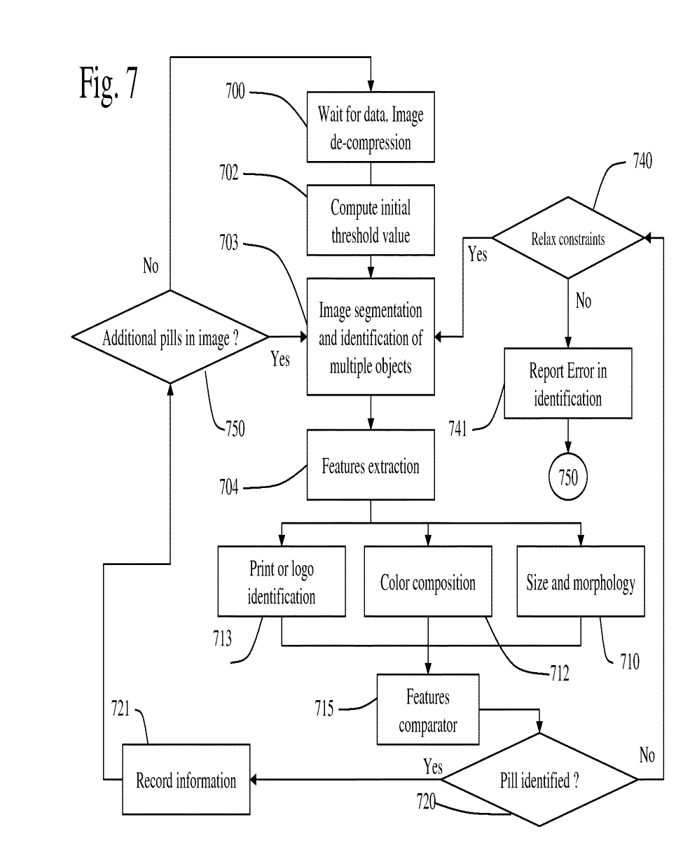

FIG. 7 is a flowchart illustrating an algorithm for image processing and medication classification, according to a preferred embodiment of the invention. This algorithm is performed on an available image or images until the medication is classified. There may be situations where classification cannot be obtained and this will be treated as an error. In step 700, upon receiving a new image, the image is de-compressed (if needed) and is represented by an array of pixels; each pixel having its color, preferably in RGB form (Red, Green and Blue values that are assigned to each pixel). In step 702, a threshold recognition value is set for this particular image. According to another embodiment of the invention, R, G and B (color) values of the various pixels may be converted to gray scale values. The gray scale form of the image is then used to calculate a threshold recognition value and is used in step 703 below. The threshold recognition value is calculated by taking, for example, the average value of all pixels in the four outer-most lines and columns of the image, assuming the user has centered the medications in the picture. Alternatively, the initial threshold recognition value may be calculated using histogram-based algorithms, as known in the literature. The threshold recognition value is applied to distinguish between a background pixel and a pixel that belongs to an object, a medication in this case. The threshold recognition may be applied to the gray scale representation of the image or separately to the color values of the pixels.

In step 703, boundary detection is performed, so as to segment the image and identify multiple objects, if present. Many boundary detection algorithms are described in the literature. According to a preferred embodiment of the invention, for each line of the image, a consecutive pixel scan is performed. The scan starts at the beginning of each line, going towards the middle of the image, until a first pixel that is not background is detected. This marks the beginning of a first object in this line. Then the consecutive pixel scan continues, until a pixel that is a background is detected. This marks the end of the first object. The scan continues and the process of detecting first and last pixels of additional objects in the image continues until the scan reaches the end of the line. Each coordinate pair of start-end points of objects is maintained in a separate list, each list corresponding to an object. Each object is assumed to be an image of a medication. It should be noted that start and end pixels may be the same, because for rounded or oval medications, the top-most line containing information of this medication may be tangential to the outside curvature of the medication, thus containing only a single pixel classified as non-background. During the scan, in order to determine whether a pixel is background or not, each pixel value, using all color information available, is compared against a pre-set threshold. Once a pixel, or a row of at least N consecutive pixels, where N is pre-determined and typically can be between one and four, been found, as described above, the point is set and recorded in an array of boundary points. It should be noted that in case the pixels in the background of the image are generally brighter than pixels belonging to the medication body, a reverse algorithm should be applied. That is, the criteria for establishing a boundary point should be where the pixel's value falls below a pre-set threshold. As an alternative, contour-following or boundary tracking algorithms, in which a boundary of each object in the image is represented as a 2 or 4-bit chain-code, may be used. These algorithms are also described in literature.

In step 704, feature extraction is performed. At this stage the boundary points of at least one medication image are already known. Therefore, algorithms can be applied in order to determine selected features, or characteristics, of the medication. There are many features that can be extracted and are described in the literature. According to a preferred embodiment of the invention, the following features are extracted. In step 710, the size and other morphological attributes of the medication are determined. Additional morphology attributes can also be computed. These attributes may be, for example, the long axis, the short axis and/or the overall shape. In step 712, color composition is computed. Color and color combination is an important distinctive feature of medications. For example, antibiotic capsules typically have two distinctive colors, one for the first half of the capsule and a different color for the other half. In step 713, according to a preferred embodiment of the invention, character recognition or a pattern matching algorithm is applied to the determine presence of printed information on the medication. Most medications have a code printed on or etched in them, which may assist in the identification process. It should be noted that print information may not be visible in the particular image being analyzed because the user is expected to place the medications in a random order and positions. However, if visible, it may contribute to the accuracy of the analysis. According to another embodiment of the invention, a cross correlation algorithm can be performed using a known and pre-stored library of logo information or other graphical information that may be printed or etched in the medication. Note that in this approach, the template, or pre-determined portion of an image that is matched against the current actual image of a medication may have to be aligned properly with the current image, or several, rotated, templates may be cross-correlated with the current image.

All features calculated are fed to a features comparator in step 715. In this step, all known or measured features are compared with stored features of all known medications. There is a match score that measures how closely the calculated features match the features of each known medication. In step 720, there is a decision making process to verify whether there is a unique match, and that the match is not ambiguous. If there is a positive match, then step 721 is carried out, where the results are recorded. Then, in step 750, if there are additional objects or medications identified in the image, analysis and classification steps starting at 703 are repeated. If all objects in the image are analyzed, control flows to step 700.

If there is no positive match, then step 740 is carried out. Evaluation is performed to determine if the non-match situation is a result of poor segmentation of the current image, or a result of insufficient information, for example, due to a medication that is poorly illuminated. If the non-match is a result of poor segmentation, a decision will be made to relax constraints, marked as “Yes” in FIG. 7. Then, segmentation parameters, such as threshold, are relaxed, and control goes to step 703 for re-segmentation and repetition of the process described herein. If the algorithm has been exhausted, that is, threshold was relaxed through a pre-determined number of times or below a certain value, and there is still no match that meets the criteria for a good match, step 741 is performed where error status is processed and handled. Following this, the algorithm goes to step 700 to wait for another image.

According to another embodiment of the invention, a fuzzy logic classifier may be used in step 715 to classify a medication, instead of, or in addition to, the features comparator described. If the fuzzy logic classifier is in addition to the features comparator, the output of both can be compared and if there is no match, an error message can be outputted. A fuzzy logic classifier may have advantages because it is easier to extend the fuzzy logic classifier to identify additional or new medications by adding rules or by modifying fuzzy membership functions. The fuzzy logic classifier may be constructed using a set of if-then rules that utilize clear linguistic terms so that communication with experts (pharmacologists) is easier and the logic is more traceable. In real-life, it is expected that the classification system will need updating as new drugs enter the market (this is also the reason it is preferred to have this software system hosted live on a central server and not on an in-home device). Updating will be achieved by adding new recognition rules. The rules can be extracted from expert knowledge or learned from examples. Other rules will be derived directly by an expert. One concrete example of such a rule is: IF (a region is half red AND half yellow AND form is elongated AND cross section is round AND . . . ) THEN (pill is Amoxicillin 250 mg).

FIG. 8 is a flowchart illustrating an algorithm for computing image authenticity, according to a preferred embodiment of the invention. It is preferred to perform image authenticity verification, to make the data collection and analysis more reliable. History shows that, in most Internet services, fraud is a major concern. People may attempt to trick the system for various reasons, by providing false medication consumption events. The use of images to report medication consumption events is more convenient, protects against unintentional user errors and against inaccurate reporting (such as unknowingly taking the wrong medication but reporting taking the correct, medication), and can be utilized to validate the report by checking the authenticity of the image provided by the user.

In step 800, the program waits for a new image to arrive. This image will be the reference image to which pre-stored images will be compared in order to ensure that the reference image is unique. A “unique” image means that the reference image is different from all pre-stored images. A way of determining if an image is the same as another, pre-stored image, is by comparing their pixels using a cross-correlation algorithm for example. (This algorithm is well defined in the literature.) If the cross correlation coefficient is 1, then the images or major portions of the images are identical. The reason is that, even if an image of the same object is taken multiple times, slight variations in positioning of the camera in both instances will generate images that are different, if examined by the values of the pixels, even if they look identical to the human eye. Another reason for the difference is the digital ‘noise’ that results from the electrical circuits in the camera, which leads to slightly different pixel values each time a picture is taken. If an image is found to be unique, there is a great probability the image is authentic, thus validating the medication consumption report.

Then, in step 802, image analysis and medication identification are performed, as depicted in FIG. 7. In step 804, the combination of medications detected in the image is noted, and is used as a key to look for all images that were input previously and are already stored in the system. According to a preferred embodiment of the invention, all images will be stored in the system, for future reference. For example, experts may want to double-check these images in case there is an Adverse Drug Event (ADE), to track down the causes for this event. In addition, this stored data may be used for the purpose of performing an image authenticity algorithm, as described herein. According to another embodiment of the invention, images will be deleted automatically from the system at the end of a pre-selected time, for example, seven years.

In step 810, all historic images having the same combination of medications are detected. According to another embodiment of the invention, all images provided by that same user may also be added to the process, as the medications people take can change over time. Two counters are set in this stage. M is the total number of images, and N is a counter that starts at 0. In step 814, image comparison is performed. Historic image number N is compared to the reference image. A variety of image similarity measures exist in the literature. According to a preferred embodiment of the invention, a Root Mean Square (RMS) may be calculated between the two images being compared, and the value compared to a pre-set threshold. A low RMS indicates that a high degree of similarity exists between the images. Another alternative is to compute a cross-correlation between the images. In step 820, if a match is found, then in step 824 an alert is issued and the reference image is declared as non-unique. Image comparisons will terminate, and control will go to step 800 again to wait for another reference (new) image. If there is no match, then N is increased by 1 in step 822. In step 830 there is a test of whether there are additional historic images (N is lesser than M). If there are additional historic images, then step 814 and the succeeding steps are performed again. If there are no additional historic images, then the image is flagged as authentic, and the program continues onto step 800, waiting for a new image.

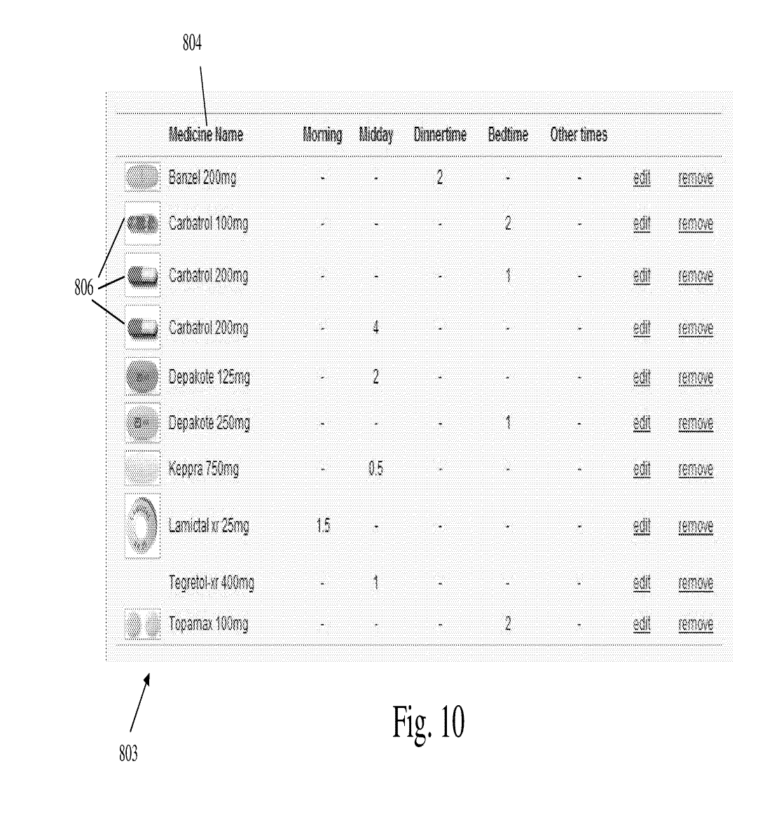

In order to encourage users to upload pictures and to assist them in their medication taking procedure, the software can use the images uploaded for additional applications. One use of the images is to create a personalized electronic chart 803 representing the drug regimen of a user, as shown in FIG. 10 for displaying the medication regimen view to the user. The apparatus for displaying this regimen includes a processor for reading the user's medication regimen from his or her personalized database and an interactive user interface. As an option, the user can print the electronic chart. FIG. 10 is a schematic illustration of one example of a user interface 803 that allows users to upload data and images of their own medications 804 and then attaches the image 806 to the name of the appropriate medication in the list of medications, creating a personalized database, which is more useful. In this case, the medication regimen data includes the set of user medications and a corresponding schedule of medication consumption. This interface uses pictures to help users to enter correctly their medication regimen or medications that have consumed, without necessarily performing image recognition, as well as to help ensure that they consume the correct medication. According to this embodiment, users must upload pictures 806 of their medications only once, when they first specify they are using that medication. Preferably, these pictures or images are captured by the user, himself.

The pictures are stored on the server, in a database associated with the user who uploaded each picture. In other words, each picture is associated with the user who uploaded that picture, preferably as a data item in the user's profile. Since image recognition tasks may overload the server, it may be beneficial in some cases to show the pictures of the medications, as uploaded by the users, as a reminder and as a visual cue to the user. This way, users can personalize their medication profiles by attaching pictures of their medicines to these medication profiles, thereby creating their own medication picture database with the image of the medication displayed adjacent the name of the medication. Since the introduction of generic medications, there are a variety of manufacturers for each generic medication. Each medication thus may look different, and it may be an aid for users to look at the actual medications they have purchased and are consuming. As seen in FIG. 10, users list their medications and upload an image that is then associated with their medication and may be used for display, verification that the right medicine is consumed (as described above) or for other purposes, such as sending the picture in an email or a cell phone message to remind the user what to take. Thus, if generic medications are purchased, the user can upload another image of the same medication (associated with the name used by the different manufacturer), so as to more readily identify which medications should be taken at which times. In addition, it is known that personalizing one's records is appealing to people and may cause them to report medication consumption events more frequently.

Further according to the invention, the web server may host an information database, which can be accessed by medication consumers, caregivers, as well as the general public, through the Internet. This support information database makes other consumers' comments and experiences, statistical analysis reports based on the large sample data of medication consumers, up-to-date post-marketing advice from the manufacturer, as well as other information, available to the users. The information database also provides an interface that enables users to perform searches for the medications that they are interested in, as well as searches to determine whether any adverse drug events are liable to results from combining certain medications. It may also provide a forum for the website user to post questions, and/or answer questions, as well as to provide a familiarity rating on certain experiences or side effects, so that other users can see how common the side effects that they are experiencing really are. Preferably, this database will be an on-line, open resource which is constantly evolving and can be edited by anyone, so that it is collaboratively created and maintained by users around the world.

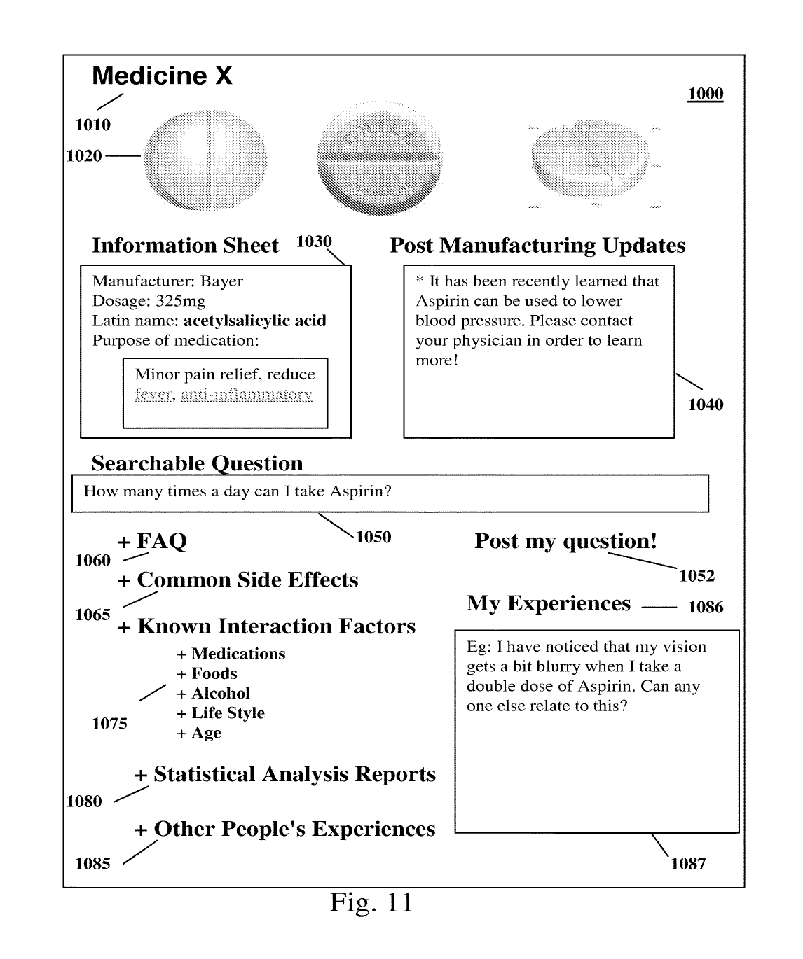

FIG. 11 shows an example of a user interface permitting searching in such a database that is generated using and organizing information collected and authenticated by the collaboration of many medication consumers uploading many events of consuming medications, commenting on their experiences related to medications, etc. In this way, valuable and relevant information is obtained from the actual consumers of medications, which is a wider and more varied group than even the most elaborate clinical trials that are performed during the pre-release phase of the medication.

FIG. 11 is a schematic illustration of one embodiment of a graphical user interface display screen 1000 for an individual medication in such a medical information database. Preferably, the following information is available on the medication page: the name of the medication 1010 (the active ingredient and/or manufacturers' trade names), a set of pictures from different angles and perspectives showing the medication 1020 (which may include a picture of the packaging as well, in order to provide additional confirmation of the identity of the medication), and a medication information sheet 1030. The medical information sheet includes information such as the manufacturer, the recommended dosage, the medication's Latin name, the purpose of the medication, as well as other information on the individual medication display screen 1000 can be considered. One section 1040 may include official manufacturer's post-marketing updates. This provides a mechanism for medication manufacturers to communicate directly with their user base on an ongoing basis.

The user can enter a question into a searchable textbox 1050, which then opens an additional display screen, if relevant answers are available. The user can also request that his question be posted, as by selecting text 1052. This will give other users the opportunity to respond to the question. The user can also select the FAQ text 1060, which opens an additional display screen with frequently asked questions. The user can also learn more about the medication by selecting the “common side effects” text 1065, reviewing statistical analysis reports 1080, reading other people's experiences 1085, or by reading the selectable, and preferably sub-selectable tree structure section entitled “known interactions” 1075. The user can provide his input to one or more fields described above. Finally, the user also can enter his own experiences and comments in a textbox 1087, which is provided under the title “my experiences” 1086.

Thus, evaluation of the medication, its effectiveness and its side effects will not end once the medication is marketed, or even once the medications are on the shelves and being consumed. Rather a vast database of up-to-date information will be created, permitting consumers, patients and caregivers to obtain more detailed and more relevant information than typically is available at present. Such an extensive and accurate collection of information regarding which medications were consumed, at which time and in what combinations will enable the determination of additional safety data about medications, such as harmful interactions with other drugs, potential damage to specific sub-populations, detecting side-effects, identify off-label utilization, and other information. It may also identify new benefits that a medication can deliver, as well as satisfy regulatory requirements for post-marketing data collection. Such information, if analyzed early, may, for instance, be used as an early indicator of problems caused by a medication. This would permit an interested party to act earlier than if only traditional sources of post-marketing data collection were relied on. Thus, such information may be invaluable as a tool for monitoring medication-related events and to enhance the effectiveness, and safety of many medications.

While this invention has been particularly shown and described with reference to preferred embodiments thereof, it will be understood by those skilled in the art that various changes in form and details may be made therein without departing from the spirit and scope of the invention as described. Those skilled in the art will recognize or be able to ascertain using no more than routine experimentation, many equivalents to the specific embodiments of the invention described specifically herein.

1-13. (canceled)

14. A method of creating an electronic chart, the method comprising:
providing an image of a medication captured by a user; and
displaying said image of said medication adjacent a name of said medication in a personalized medication regimen of said user.

15. The method according to claim 14, wherein said step of providing includes capturing said image by said user.

16. Apparatus for displaying a medication regimen of a user, the apparatus comprising:
a processor for reading a medication regimen of a user from a personalized database representing medication regimen data of the user for display of a medication regimen;
an interactive user interface for uploading data and images by said user to said personalized database; wherein said medication regimen data comprises a set of user medications and a corresponding schedule of medication consumption; and wherein said database further includes at least one image of a medication uploaded by the user and associated with each name of a medication; and
a display for displaying said medication regimen view of the user; wherein said medication regimen includes a display of said image of said medication adjacent said name of said medication.

17. The method according to claim 14, wherein the image further comprises adjacent to the image, at least one of: a user identifier, time and date.

18. The method according to claim 14, wherein the image further comprises adjacent to the image: at least one of: an active ingredient of the medication; a Latin name of the medication; a dosage; and a name of a manufacturer.

19. The method according to claim 14, wherein providing and displaying on the electronic chart are protected by a username and password on an electric device such as a cell phone, or a PC or other computer.

20. The method according to claim 14, wherein capturing the image of said medication for displaying on the chart is performed once.

21. The method according to claim 14, wherein capturing the image of said medication for displaying on the chart is performed iteratively for each change in dosage or manufacturer of the medication.

22. The method according to claim 14, further comprising storing the image uploaded by the user as a data item in a profile of the user.

23. The method according to claim 21, further comprising capturing a second image of the medication made by a second manufacturer of the medication.

24. The apparatus according to claim 16, wherein the image is a photograph of each medication of the set of medications, the photograph captured and uploaded by the user.

25. The apparatus according to claim 16, the interactive user interface further comprising a medical information sheet having manufacturer's post-marketing updates.

26. The apparatus according to claim 16, wherein said personalized database uploaded by the user comprises at least one of questions, side effect experiences, and drug interaction experiences.

27. The apparatus according to claim 25, wherein the manufacturer's updates comprise at least one of an off-label usage, a potential damage to a sub-population, and a new benefit.

28. The apparatus according to claim 16 further comprising a web server hosting an information database accessed by the user, the caregiver and the general public through the internet.

29. The apparatus according to claim 28, wherein the web server further comprises a user interface database generated organizing information collected and authenticated by collaboration of a plurality of medication users uploading events of consuming medications and comments describing experiences related to medications, wherein the database comprises valuable clinical information from a wide population.

30. The apparatus according to claim 16, wherein the medication regimen display identifies the time for the next dose.

31. The apparatus according to claim 16, wherein the interactive user interface comprises the user actuation of the time of the next dose or modification of the alert feature for the medication.
